(19) United States
(12) Patent Application Publication
(10) Pub. No.: US 2026/0371098 A1
(43) Pub. Date: Nov. 19, 2026

(54) WIRELESS COMMUNICATION SYSTEM, WIRELESS COMMUNICATION METHOD, WIRELESS COMMUNICATION DEVICE, AND WIRELESS COMMUNICATION PROGRAM

(71) Applicant: NTT, Inc., Tokyo (JP)

(72) Inventors: Masayoshi Nabeshima, Musashino-shi, Tokyo (JP); Tomoaki Ogawa, Musashino-shi, Tokyo (JP)

(21) Appl. No.: 19/487,021

(22) PCT Filed: May 25, 2023
(86) PCT No.: PCT/JP2023/019501

§ 371 Date: Nov. 24, 2025

(51) Int. Cl. H04W 16/18; H04B 17/309

(52) U.S. Cl. CPC H04W 16/18; H04B 17/309

(57) ABSTRACT

The present disclosure relates to a wireless communication system, a wireless communication method, a wireless communication device, and a wireless communication program. The wireless communication system includes a server and a site survey tool. The server includes a mission registration unit and a mission management unit. The mission registration unit is configured to perform a process of registering a mission set corresponding to character of an engineer. The site survey tool is configured to perform a process of transmitting character input by an engineer and a terminal identification number of the site survey tool to a server. The mission management unit is configured to perform a determination process of making a determination corresponding to a mission selected as the terminal identification number, and a process of transmitting the information acquired in the determination process to the site survey tool corresponding to the terminal identification number. The site survey tool is further configured to perform a process of displaying the information acquired in the determination process.

### TECHNICAL FIELD

The present disclosure relates to a wireless communication system, a wireless communication method, a wireless communication device, and a wireless communication program.

### BACKGROUND ART

When a wireless LAN is installed, a site survey is performed. The site survey is a radio wave survey performed to determine the number of access points (AP) installed, installation positions, radio wave intensities, channels to be used, and the like when a wireless LAN is newly constructed.

### CITATION LIST

### Non Patent Literature

Non Patent Literature 1: “Bijinesu Genba Deno Geemifikeshon Katsuyou Gijutsu To Kensho (in Japanese) (Gamification Utilization Technology and Verification in Business Site)”, NTT Technical Journal, April 2015, p 42-45, Non Patent Literature 2: “Buka Wo Sono Ki Ni Saseru “Shigoto No Geemuka” No Kouryakuhou (in Japanese) (Strategies for ‘Gamifying Work’ to Motivate Subordinates”, Toyo Keizai Online, Jan. 17, 2022, <URL: https://toyokeizai.net/articles/-/500000>

### SUMMARY OF INVENTION

### Technical Problem

In the site survey, each engineer performs radio wave measurement using his or her site survey tool. Since this task is a simple task, there is a problem with the motivation of engineers who have character unsuited to simple tasks.

In order to solve the above-described problem, a first object of the present disclosure is to provide a wireless communication system capable of improving the motivation of engineers for simple tasks performed in a site survey.

In addition, a second object of the present disclosure is to provide a wireless communication method capable of improving motivation of engineers for simple tasks performed in a site survey.

In addition, a third object of the present disclosure is to provide a wireless communication device capable of improving motivation of engineers for simple tasks performed in a site survey.

In addition, a fourth object of the present disclosure is to provide a wireless communication program capable of improving motivation of engineers for simple tasks performed in a site survey.

### Solution to Problem

According to a first aspect of the present disclosure, preferably, there is provided a wireless communication system including a server and a site survey tool, in which the server includes a mission registration unit and a mission management unit, the mission registration unit is configured to perform a process of registering a mission set corresponding to character of an engineer, the site survey tool is configured to perform a process of transmitting character input by an engineer and a terminal identification number of the site survey tool to the server, the mission management unit is configured to perform a determination process of making a determination corresponding to a mission selected as the terminal identification number, and a process of transmitting information acquired in the determination process to a site survey tool corresponding to the terminal identification number, and the site survey tool is configured to perform a process of displaying the information acquired in the determination process.

According to a second aspect of the present disclosure, preferably, there is provided a wireless communication method implemented by a wireless communication system having a server and a site survey tool, in which the server includes a mission registration unit and a mission management unit, and the method includes: by the mission registration unit, registering a mission set corresponding to character of an engineer; by the site survey tool, transmitting character input by an engineer and a terminal identification number of the site survey tool to the server; by the mission management unit, making a determination corresponding to a mission selected as the terminal identification number, and transmitting information acquired in the determination to a site survey tool corresponding to the terminal identification number; and by the site survey tool, displaying the information acquired in the determination.

According to a third aspect of the present disclosure, preferably, there is provided a wireless communication device that performs wireless communication with a site survey tool, the device configured to perform a process of registering a mission set corresponding to character of an engineer, a process of receiving character input by an engineer and a terminal identification number of the site survey tool from the site survey tool, a determination process of making a determination corresponding to a mission selected as the terminal identification number, and a process of transmitting the information acquired in the determination process to the site survey tool corresponding to the terminal identification number.

According to a fourth aspect of the present disclosure, preferably, there is provided a wireless communication program for causing a wireless communication device to perform wireless communication with a site survey tool, the program for causing a computer to perform a process of registering a mission set corresponding to character of an engineer, a process of receiving character input by an engineer and a terminal identification number of the site survey tool from the site survey tool, a determination process of making a determination corresponding to a mission selected as the terminal identification number, and a process of transmitting the information acquired in the determination process to the site survey tool corresponding to the terminal identification number.

### Advantageous Effects of Invention

According to the first to fourth aspects of the present disclosure, it is possible to improve the motivation of engineers for the simple tasks performed in a site survey.

### BRIEF DESCRIPTION OF DRAWINGS

FIG. 1 is a diagram showing a wireless communication system of a comparative example.

FIG. 2 is a diagram showing a wireless communication system according to Embodiment 1 of the present disclosure.

FIG. 3 is a view showing a hardware configuration of a server according to Embodiment 1 of the present disclosure.

FIG. 4 is a flowchart showing a process of a mission performed by a mission management unit according to Embodiment 1 of the present disclosure.

FIG. 5 is a flowchart showing a first example of a determination process performed by the mission management unit according to Embodiment 1 of the present disclosure.

FIG. 6 is a flowchart showing a second example of the determination process performed by the mission management unit according to Embodiment 1 of the present disclosure.

FIG. 7 is a flowchart showing a third example of the determination process performed by the mission management unit according to Embodiment 1 of the present disclosure.

FIG. 8 is a diagram showing a wireless communication method according to Embodiment 1 of the present disclosure.

### DESCRIPTION OF EMBODIMENTS

### Embodiment 1

### [Wireless Communication System of Comparative Example]

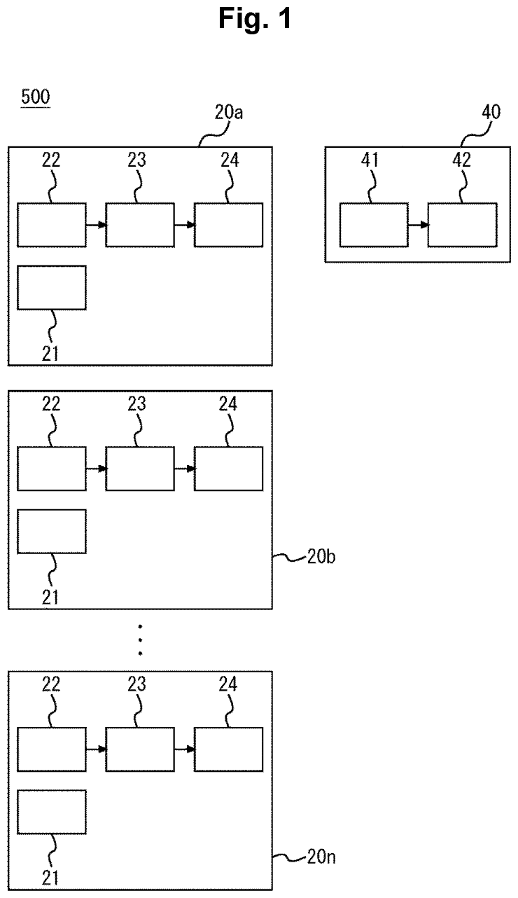

FIG. 1 is a diagram showing a wireless communication system of a comparative example. A wireless communication system 500 of the comparative example is a system that enables a site survey by providing site survey tools 20a to 20n carried and used by a plurality of engineers and a server 40 operated by a senior engineer.

The site survey is a radio wave survey performed when a wireless LAN is designed. In the site survey, when a wireless LAN is newly constructed, the design of the number of access points installed, installation positions, radio wave intensity, channels to be used, and the like is determined.

The procedure of the site survey is shown below with reference to FIG. 1. First, as a preliminary preparation, a skilled senior engineer selects the number of installed APs, installation locations, and measurement points of radio waves based on a floor diagram for constructing the wireless LAN. Next, the senior engineer determines radio wave measurement points to be assigned to each engineer, and prepares for reading the floor diagrams corresponding to the site survey tools 20a to 20n carried by each engineer. Further, the senior engineer temporarily installs the AP at the selected installation location on the site where the wireless LAN is constructed.

Next, each engineer performs radio wave measurement using his or her site survey tool. Note that, since the site survey tools 20a to 20n included in the wireless communication system 500 have the same configuration, only a case where an engineer uses the site survey tool 20a will be described in detail here.

The site survey tool 20a includes a setting unit 21. The engineer imports a floor drawing on which the engineer conducts the site survey into the site survey tool 20a via the setting unit 21. The imported floor drawing is displayed on a click determination unit 22.

When arriving at the radio wave measurement point that the engineer himself or herself is in charge of, the engineer clicks a point that matches the current location of the engineer himself or herself on the drawing displayed on the click determination unit 22. When the click determination unit 22 recognizes the click, a channel scanning unit 23 performs radio wave measurement. A transmission unit 24 transmits the measured radio wave information to server 40. Thus, the radio wave measurement at a certain radio wave measurement point is completed.

When radio wave measurement at a certain radio wave measurement point is completed, the engineer moves to the next radio wave measurement point and performs similar radio wave measurement. The engineer repeats this on his or her floor.

In the server 40, a reception unit 41 receives the radio wave information transmitted from the transmission unit 24. The reception unit 41 transmits the received radio wave information to a radio visualization unit 42. The radio visualization unit 42 visualizes a radio wave condition on the entire floor based on the received radio wave information.

### [Wireless Communication System According to Embodiment 1 of Present Disclosure]

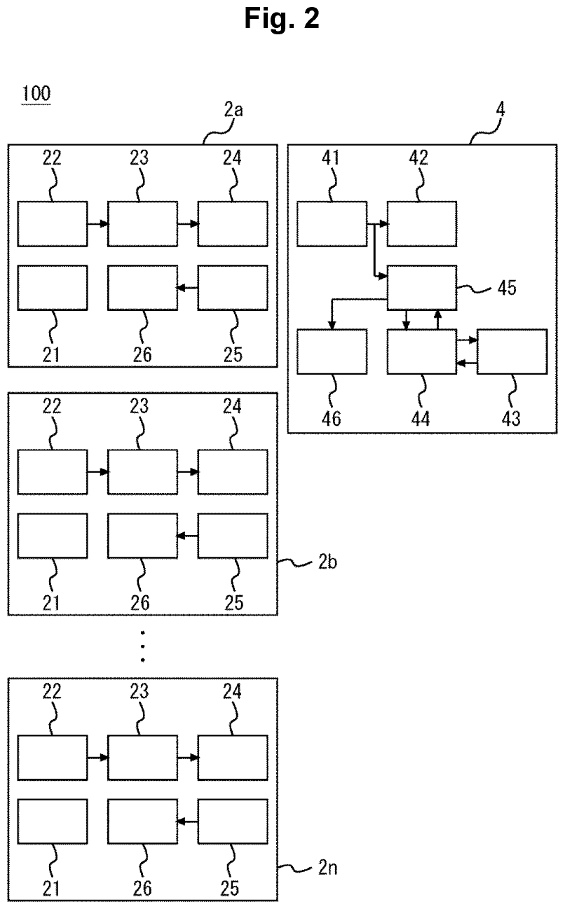

FIG. 2 is a diagram showing a wireless communication system according to Embodiment 1 of the present disclosure. A wireless communication system 100 according to the present embodiment is a system that enables a site survey by providing the site survey tools 20a to 20n carried and used by a plurality of engineers and a server 4 operated by a senior engineer. The wireless communication system 100 is different from the wireless communication system 500 of the comparative example in having a configuration for presenting a mission.

The procedure of the site survey according to the present embodiment will be described below with reference to FIG. 2. First, as a preliminary preparation, a skilled senior engineer devises a mission to be presented to each engineer in addition to the preliminary preparation performed in the site survey of the comparative example. This mission is the one which is set corresponding to the character of the engineer. Then, the devised mission is registered in a mission registration unit 43. Registration as a mission includes, for example, the character, a character string indicating the mission, and a clear condition of the mission. Details of the mission will be described later.

The mission registration unit 43 classifies each registered mission by character and assigns numbers in order from 1. This number is set as the mission determination value. Then, the total number of missions for each character is transmitted to a mission selection unit 44.

Next, each engineer performs radio wave measurement using his or her site survey tool. Note that, since the site survey tools 2a to 2n included in the wireless communication system 100 have the same configuration, only a case where the engineer uses the site survey tool 2a will be described in detail here.

The engineer sets his or her character and the identification number of the terminal in the setting unit 21 included in the site survey tool 2a. The character of the engineer himself or herself may be self-reported or may be determined using the Bartle test to be described later. Further, the engineer imports the floor drawing on which the engineer conducts the site survey into the site survey tool 2a via the setting unit 21. The imported floor drawing is displayed on a click determination unit 22.

When arriving at the radio wave measurement point that the engineer himself or herself is in charge of, the engineer clicks a point that matches the current location of the engineer himself or herself on the drawing displayed on the click determination unit 22. When the click determination unit 22 recognizes the click, a channel scanning unit 23 performs radio wave measurement. In addition to the measured radio wave information, the channel scanning unit 23 transmits the character and the terminal identification number of the engineer himself or herself set in the setting unit 21 to the transmission unit 24. The transmission unit 24 transmits the received information to the server 4.

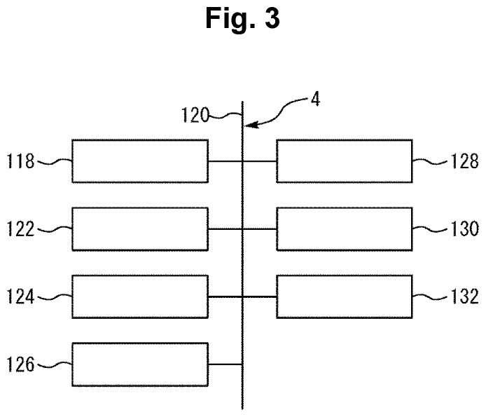

In the server 4, the reception unit 41 receives the information transmitted from the transmission unit 24. The reception unit 41 transmits the received information to the radio visualization unit 42 and a mission management unit 45. The radio visualization unit 42 visualizes the radio wave condition on the entire floor based on the radio wave information included in the received information. The mission management unit 45 performs a process of the mission based on the received information and a flowchart to be described later with reference to FIG. 3. Then, the mission management unit 45 transmits the information acquired in the process of the mission to the transmission unit 46. The information acquired here is, for example, a terminal identification number, a character string of a mission, or a current value of a value used for determining the mission.

The transmission unit 46 transmits the acquired information to the reception unit 25 of the site survey tool corresponding to the received terminal identification number. The reception unit 25 transmits the acquired information to a mission display unit 26. The mission display unit 26 displays the received information on the screen.

As described above, the radio wave measurement at a certain radio wave measurement point is completed, and at the same time, the mission corresponding to the character of the engineer himself or herself and the progress status thereof are updated. When radio wave measurement at a certain radio wave measurement point is completed, the engineer moves to the next radio wave measurement point and performs similar radio wave measurement. The engineer repeats this on his or her floor.

Since the server 4 can collect radio wave information at each radio wave measurement point by the above-described method, the radio wave condition of the entire floor constituting the wireless LAN is visualized. In the process, when the progress status of the mission and the like are displayed on the site survey tool, the engineer acts while aiming to clear the mission, and thus it is possible to expect improvement of the motivation of the engineer.

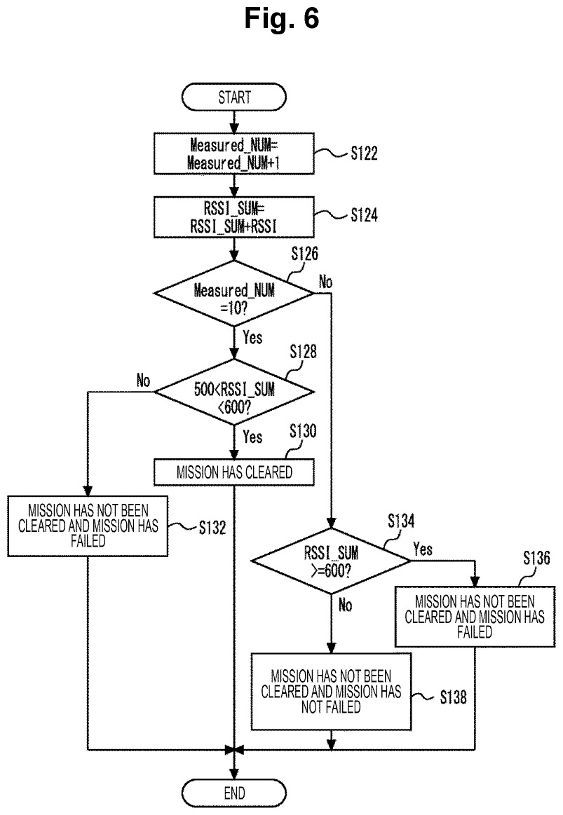

FIG. 6 is a view showing a hardware configuration of a server according to Embodiment 1 of the present disclosure. The server 4 includes a CPU 118. The CPU 118 is connected to a bus line 120. Memory devices such as a ROM 122, a RAM 124, and a storage 126 are connected to the bus line 120. The memory device stores a wireless communication program to be executed by the CPU 118. The server 4 can implement functions specific to the present embodiment by the CPU 118 executing the wireless communication program.

A communication interface 128 is also connected to the bus line 120. The server 4 implements communication with a network via the communication interface 128. An operation unit 130 and a display unit 132 are further connected to the bus line 120. The operation unit 130 and the display unit 132 function as a user interface for handling the server 4.

As described above, in the server 4, the CPU 118 executes the wireless communication program, and accordingly, a function specific to the present embodiment can be implemented. In other words, the server 4 can also be implemented by a computer and the program. In addition, the program can also be provided by being recorded in a recording medium or through a network.

### Mission According to First Embodiment of Present Disclosure

Details of the mission according to Embodiment 1 of the present disclosure will be described. An object of the present disclosure is to improve motivation of engineers by using gamification. The gamification is to apply an element used in a game such as a game rule to an object other than a game. For example, Non Patent Literature 1 and 2 disclose a method for utilizing gamification in business.

Since the task performed by each engineer in the site survey is a simple task, there is a problem that the motivation of the engineer who is not good at simple tasks decreases. In order to solve this problem, in the present disclosure, a mission, which is an element used in a game, is presented during task of conducting a site survey. By setting this mission corresponding to the character of each engineer and allowing each engineer to perform tasks while achieving the mission, an effect of improving motivation can be obtained.

The mission presented here is a goal to be achieved during the task, and is determined corresponding to the character of the engineer. The character referred to herein may be, for example, a classification used by a game researcher, Richard Bartle, for a game player.

Richard Bartle, through his self-devised “Bartle Test”, classifies player characters into the following four types. The first character is Achiever, who tends to find joy in accomplishing tasks. The second character is Explorer, who finds joy in exploration, discovery, or embarking on journeys. The third character is Socializer, who finds joy in interacting with others. The fourth character is Killer, who tends to find joy in achieving superiority over others through competition or rankings.

An appropriate mission is set corresponding to the above-mentioned character types. For example, for an engineer whose character corresponds to Achiever, a mission to achieve goals related to the number of measurements or measurement values is set. In addition, for an engineer whose character corresponds Explorer, a mission to explore challenges related to the number of measurements or measurement values is set.

In the present disclosure, when a senior engineer sets a mission, necessary information is registered in the mission registration unit 43. Here, as described above, registration as a mission includes, for example, the character, a character string indicating the mission, and a clear condition of the mission. A more specific example of each item is shown in Table 1.

TABLE 1

| | Character string | Clearing condition |
|---|---|---|
| Character | indicating mission | of mission |
| Achiever | Complete measurement 10 | Measured_NUM = 10 |
| | times. | |
| Achiever | Make total value of | RSSI_SUM > 1000 |
| | absolute values of | |
| | measured RSSI exceed 1000. | |
| Explorer | Find the point where RSSI | −55 < RSSI < − 50 |
| | is within the range of −50 | |
| | to −55. | |
| Explorer | Set total value of | Measured_NUM = 10, |
| | absolute values of RSSI in | 500 < RSSI_SUM < 600 |
| | 10 measurements to fall | |
| | within the range of 500 to | |
| | 600. | |

### Process of Mission According to Embodiment 1 of Present Disclosure

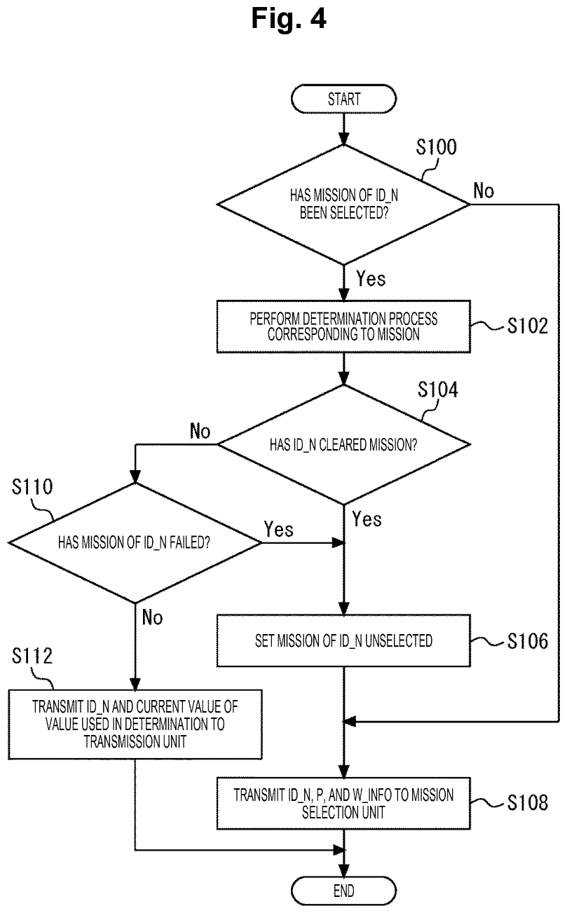

FIG. 4 is a flowchart showing a process of a mission performed by the mission management unit according to Embodiment 1 of the present disclosure. In the flowchart of FIG. 4, when the terminal identification number is N, the terminal identification number is denoted as “ID_N”, the character of the engineer himself or herself is denoted as “P”, and the radio wave information is denoted as “W_INFO”.

First, in step 100, it is checked whether the mission of ID_N has been selected. In a case where the mission has been selected, the process proceeds to step 102. In a case where no mission has not been selected, the process proceeds to step 108.

In step 102, the determination process corresponding to the mission is performed, and the process proceeds to step 104. Specific examples of the determination process will be described below.

In step 104, it is checked whether ID_N has cleared the mission. In a case where the mission is cleared, the process proceeds to step 106. In a case where the mission is not cleared, the process proceeds to step 110.

In step 106, the mission of ID_N is set to unselected, and the process proceeds to step 108. In step 108, ID_N, P, and W_INFO are transmitted to the mission selection unit 44, and the process ends.

Upon receiving ID_N, P, and W_INFO from the mission management unit, the mission selection unit 44 calculates a mission determination value corresponding to P, and transmits the mission determination value and P to the mission registration unit 43.

For example, in a case where P is Achiever, one is calculated from the numbers included in 1 to N a based on W_INFO, and is set as the mission determination value. Here, N a is the total number of missions for Achiever transmitted from the mission registration unit 43. Alternatively, in a case where P is Explorer, one is calculated from the numbers included in 1 to N_e based on W_INFO and set as the mission determination value. Here, N_e is the total number of missions for Explorer transmitted from the mission registration unit 43.

Upon receiving the mission determination value and P from the mission selection unit, the mission registration unit 43 selects P and a mission corresponding to the mission determination value, and transmits a character string indicating the corresponding mission and a clearing condition of the mission, to the mission selection unit 44. The mission selection unit 44 transmits the received character string indicating the mission and the clearing condition of the mission, to the mission management unit 45 together with ID_N.

Upon receiving ID_N, the character string indicating the mission, and the clearing condition of the mission from the mission selection unit 44, the mission management unit 45 sets the mission of ID_N as selected. In addition, the mission management unit 45 transmits ID_N and the character string of the mission to the transmission unit 46. Further, the mission management unit 45 uses the received clear condition of the mission in the determination process to be described later.

In step 110, ID_N checks whether the mission has failed. In a case where the mission has failed, the process proceeds to step 106. In a case where the mission has not failed, the process proceeds to step 112.

In step 112, ID_N and the current value of the value used in the determination are transmitted to the transmission unit 46, and the process ends.

When receiving ID_N and the current value of the determined value from the mission management unit 45, the transmission unit 46 transmits the current value of the value used in the determination to the reception unit 25 of the site survey tool corresponding to ID_N.

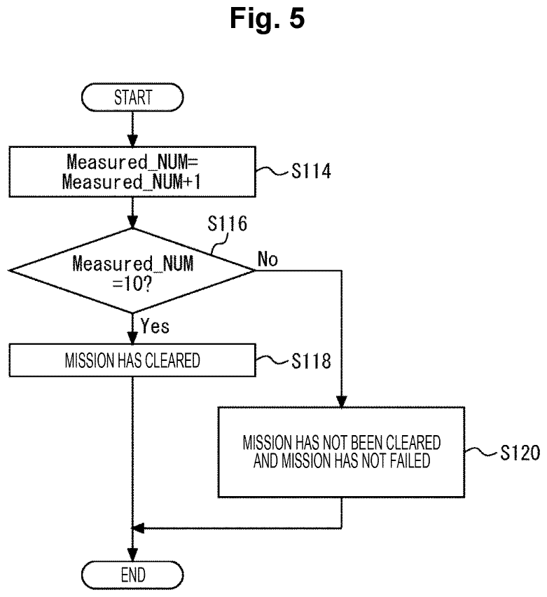

FIG. 5 is a flowchart showing a first example of a determination process performed by the mission management unit according to Embodiment 1 of the present disclosure. Here, an example of the determination process in the mission for Achiever is shown.

First, in step 114, 1 is added to Measured_NUM, and the process proceeds to step 116. In addition, Measured_NUM indicates the number of radio wave measurements during a specific mission performing period. Next, in step 116, it is checked whether Measured_NUM=10 is satisfied. When Measured_NUM=10 is satisfied, the process proceeds to step 118. When Measured_NUM=10 is not satisfied, the process proceeds to step 120.

In step 118, it is determined that the mission has been cleared, and the determination process ends. In step 120, it is determined that the mission has not been cleared and the mission has not failed, and the determination process ends.

FIG. 6 is a flowchart showing a second example of the determination process performed by the mission management unit according to Embodiment 1 of the present disclosure. Here, an example of the determination process in the mission for Explorer is shown.

First, in step 122, 1 is added to Measured_NUM, and the process proceeds to step 124. Next, in step 124, the absolute value of the RSSI acquired by radio wave measurement is added to RSSI_SUM, and the process proceeds to step 126. Note that RSSI_SUM indicates a sum of absolute values of RSSI of radio waves measured during a specific mission performing period.

Next, in step 126, it is checked whether Measured_NUM=10 is satisfied. When Measured_NUM=10 is satisfied, the process proceeds to step 128. When Measured_NUM=10 is not satisfied, the process proceeds to step 134.

In step 128, it is checked whether 500<RSSI_SUM<600. When 500<RSSI_SUM<600 is satisfied, the process proceeds to step 130. When 500<RSSI_SUM<600 is not satisfied, the process proceeds to step 132.

In step 130, it is determined that the mission has been cleared, and the determination process ends. In step 132, it is determined that the mission has not been cleared and the mission has failed, and the determination process ends.

In step 134, it is checked whether RSSI_SUM≥600. When RSSI_SUM≥600 is satisfied, the process proceeds to step 136. When RSSI_SUM≥600 is not satisfied, the process proceeds to step 138.

In step 136, it is determined that the mission has not been cleared and the mission has failed, and the determination process ends. In step 138, it is determined that the mission has not been cleared and the mission has not failed, and the determination process ends.

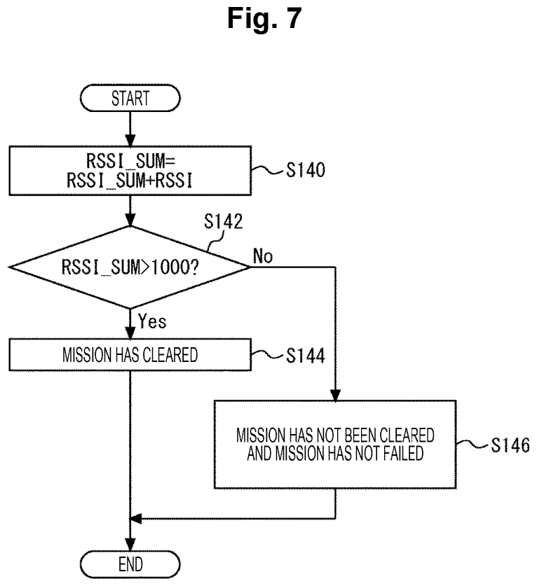

FIG. 7 is a flowchart showing a third example of the determination process performed by the mission management unit according to Embodiment 1 of the present disclosure. Here, an example of the determination process in the mission for Achiever is shown.

First, in step 140, the absolute value of the RSSI acquired by radio wave measurement is added to RSSI_SUM, and the process proceeds to step 142.

Next, in step 142, it is checked whether RSSI_SUM>1000 is satisfied. When RSSI_SUM>1000 is satisfied, the process proceeds to step 144. When RSSI_SUM>1000 is not satisfied, the process proceeds to step 146.

In step 144, it is determined that the mission has been cleared, and the determination process ends. In step 146, it is determined that the mission has not been cleared and the mission has not failed, and the determination process ends.

### Example of Wireless Communication Method According to Embodiment 1 of Present Disclosure

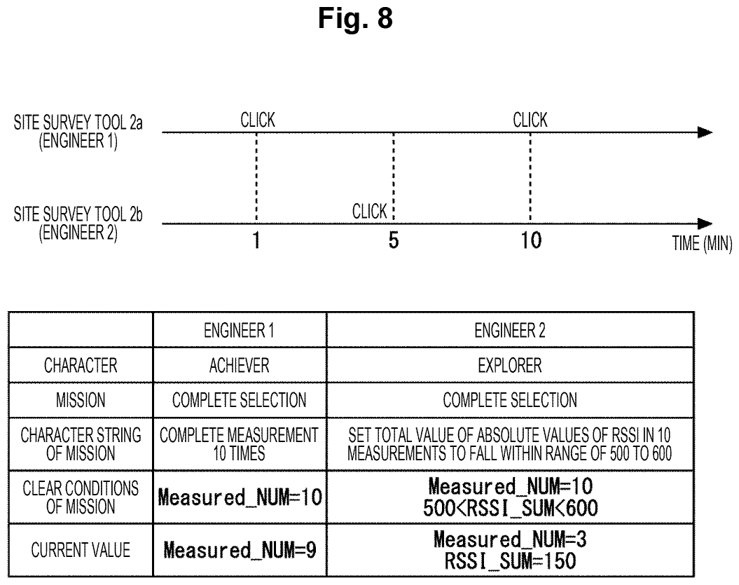

FIG. 8 is a diagram showing a wireless communication method according to Embodiment 1 of the present disclosure. The upper diagram shows click timings recognized in the site survey tool 2a used by an engineer 1 and the site survey tool 2b used by an engineer 2. The horizontal axis represents time. That is, the engineer 1 clicks after 1 minute and 10 minutes from the reference time, and the engineer 2 clicks after 5 minutes.

The table below also shows the characters and current mission status of the engineers 1 and 2 at the reference time. Note that the terminal identification number of the site survey tool 2a is set to 1, and the terminal identification number of the site survey tool 2b is set to 2.

The example shown in FIG. 8 will be described in chronological order. First, one minute after the reference time, the engineer 1 uses the site survey tool 2a to click a point that matches the current value of the engineer 1 himself or herself. When the click determination unit 22 recognizes the click, a channel scanning unit 23 performs radio wave measurement. Here, it is assumed that the channel scanning unit 23 obtains information of RSSI=−50 as radio wave information. The transmission unit 24 transmits, to the server 4, RSSI=−50, terminal identification number ID_1, and character P=Achiever, which are radio wave information.

In the server 4, the reception unit 41 receives the information transmitted from the transmission unit 24. The reception unit 41 transmits the received information to the radio visualization unit 42 and a mission management unit 45.

The mission management unit 45 starts a process of the mission according to the flowchart of FIG. 4. First, in step 100, it is checked whether the mission of ID_1 has been selected. Since the mission of ID_1 has been selected, the process proceeds to step 102, and the determination process corresponding to the mission is performed.

The determination process is performed according to the flowchart of FIG. 5. First, in step 114, Measured_NUM=9, which is the current value of the site survey tool 2a, is changed to Measured_NUM=9+1=10, and the process proceeds to step 116. Next, in step 116, Measured_NUM=10, and thus, the process proceeds to step 118. In step 118, it is determined that the mission has been cleared, and the determination process ends.

When the determination process is performed, the process proceeds to step 104. Since it is determined in step 104 that ID_1 has cleared the mission, the process proceeds to step 106. In step 106, the mission of ID_1 is set to unselected, and the process proceeds to step 108. In step 108, ID_1, P=Achiever, and RSSI=−50 of W_INFO are transmitted to the mission selection unit 44, and the process ends.

Since P=Achiever, the mission selection unit 44 calculates a mission determination value from the total number of missions for Achiever based on RSSI=−50 which is W_INFO. Here, assuming that N a is 10 and the mission determination value is “a value obtained by adding 1 to a remainder obtained by dividing W_INFO by N a”, the mission determination value is 1. Therefore, the mission selection unit 44 transmits the mission determination value=1 and P=Achiever to the mission registration unit 43.

Upon receiving the mission determination value=1 and P=Achiever from the mission selection unit, the mission registration unit 43 selects a mission corresponding to P=Achiever and mission determination value=1. Here, it is assumed that the mission stored as the first mission for Achiever is selected. The mission registration unit 43 transmits the character string indicating the corresponding mission and the clear condition of the mission, to the mission selection unit 44. Here, the character string indicating the mission is “the total value of the absolute values of the measured RSSI exceeds 1000”, and the clear condition is “RSSI_SUM 1000”.

The mission selection unit 44 transmits the character string indicating the received mission “the total value of the absolute values of the measured RSSI exceeds 1000” and the clear condition “RSSI_SUM>1000”, to the mission management unit 45 together with ID_1.

Upon receiving ID_1, the character string indicating the mission, and the clearing condition of the mission from the mission selection unit 44, the mission management unit 45 sets the mission of ID_1 as selected. In addition, the mission management unit 45 transmits ID_1 and the character string of the mission “the total value of the absolute values of the measured RSSI exceeds 1000” to the transmission unit 46. Further, the mission management unit 45 uses the clear condition “RSSI_SUM>1000” of the received mission in the determination process.

The transmission unit 46 transmits the character string of the mission “the total value of the absolute values of the measured RSSI exceeds 1000” to the site survey tool 2a of which the terminal identification number is ID_1. The reception unit 25 of the site survey tool 2a transmits the character string of the mission “the total value of the absolute values of the measured RSSI exceeds 1000” of the received mission to the mission display unit 26. The mission display unit 26 displays the character string “the total value of the absolute values of the measured RSSI exceeds 1000” of the received mission on the screen. As a result, the engineer 1 can check a new mission.

Next, five minute after the reference time, the engineer 2 uses the site survey tool 2b to click a point that matches the current value of the engineer 2 himself or herself. When the click determination unit 22 recognizes the click, a channel scanning unit 23 performs radio wave measurement. Here, it is assumed that the channel scanning unit 23 obtains information of RSSI=−60 as radio wave information. The transmission unit 24 transmits, to the server 4, RSSI=−60, terminal identification number ID_2, and character P=Explorer, which are radio wave information.

In the server 4, the reception unit 41 receives the information transmitted from the transmission unit 24. The reception unit 41 transmits the received information to the radio visualization unit 42 and a mission management unit 45.

The mission management unit 45 starts a process of the mission according to the flowchart of FIG. 4. First, in step 100, it is checked whether the mission of ID_2 has been selected. Since the mission of ID_2 has been selected, the process proceeds to step 102, and the determination process corresponding to the mission is performed.

The determination process is performed according to the flowchart of FIG. 6. First, in step 122, Measured_NUM=3, which is the current value of the site survey tool 2b, is changed to Measured_NUM=3+1=4, and the process proceeds to step 124. In step 124, RSSI_SUM=150, which is the current value of the site survey tool 2b, is changed to RSSI_SUM=150+60=210, and the process proceeds to step 126.

In step 126, Measured_NUM=10 is not satisfied, and thus the process proceeds to step 134. In step 134, since RSSI_SUM>600 is not satisfied, the process proceeds to step 138. In step 138, it is determined that the mission has not been cleared and the mission has not failed, and the determination process ends.

When the determination process is performed, the process proceeds to step 104. Since it is determined in step 104 that ID_2 has not cleared the mission, the process proceeds to step 110. In step 110, ID_2 has not failed the mission, and thus the process proceeds to step 112. In step 112, ID_2 and Measured_NUM=4 and RSSI_SUM=210, which are the current values of the values used in the determination, are transmitted to the transmission unit 46, and the process ends.

The transmission unit 46 transmits Measured_NUM=4 and RSSI_SUM=210, which are the current values of the values used in the determination, to the site survey tool 2b of which the terminal identification number is ID_2. The reception unit 25 of the site survey tool 2b transmits the received current value to the mission display unit 26. The mission display unit 26 displays the received current value on the screen. As a result, the engineer 2 can check the current progress.

Next, ten minute after the reference time, the engineer 1 uses the site survey tool 2a to click a point that matches the current value of the engineer 1 himself or herself. When the click determination unit 22 recognizes the click, a channel scanning unit 23 performs radio wave measurement. Here, it is assumed that the channel scanning unit 23 obtains information of RSSI=−55 as radio wave information. The transmission unit 24 transmits, to the server 4, RSSI=−55, terminal identification number ID_1, and character P=Achiever, which are radio wave information.

In the server 4, the reception unit 41 receives the information transmitted from the transmission unit 24. The reception unit 41 transmits the received information to the radio visualization unit 42 and a mission management unit 45.

The mission management unit 45 starts a process of the mission according to the flowchart of FIG. 4. First, in step 100, it is checked whether the mission of ID_1 has been selected. Since the mission of ID_1 has been selected, the process proceeds to step 102, and the determination process corresponding to the mission is performed.

The determination process is performed according to the flowchart of FIG. 7. First, in step 140, RSSI_SUM=0, which is the current value of the site survey tool 2a, is changed to RSSI_SUM=0+55=55, and the process proceeds to step 142. Next, in step 142, since RSSI_SUM=55>1000 is not satisfied, the process proceeds to step 146. In step 146, it is determined that the mission has not been cleared and the mission has not failed, and the determination process ends.

When the determination process is performed, the process proceeds to step 104. Since it is determined in step 104 that ID_1 has not cleared the mission, the process proceeds to step 110. In step 110, ID_1 has not failed the mission, and thus the process proceeds to step 112. In step 112, ID_1 and RSSI_SUM=55, which are the current values of the values used in the determination, are transmitted to the transmission unit 46, and the process ends.

The transmission unit 46 transmits RSSI_SUM=55, which are the current values of the values used in the determination, to the site survey tool 2b of which the terminal identification number is ID_1. The reception unit 25 of the site survey tool 2a transmits the received current value to the mission display unit 26. The mission display unit 26 displays the received current value on the screen. As a result, the engineer 1 can check the current progress.

### REFERENCE SIGNS LIST

2a Site Survey Tool
2b Site Survey Tool
4 Server
20a Site Survey Tool
20b Site Survey Tool
40 Server
43 Mission Registration Unit
45 Mission Management Unit
100 Wireless Communication System
500 Wireless Communication System

1. A wireless communication system comprising a server and a site survey tool, wherein
the server includes a mission registration unit that includes one or more processors and a mission management unit that includes one or more processors,
the mission registration unit is configured to perform a process of registering a mission set corresponding to character of an engineer,
the site survey tool, including one or more processors, is configured to perform a process of transmitting character input by an engineer and a terminal identification number of the site survey tool to the server,
the mission management unit is configured to perform
a determination process of making a determination corresponding to a mission selected as the terminal identification number, and
a process of transmitting information acquired in the determination process to a site survey tool corresponding to the terminal identification number, and
the site survey tool is configured to perform
a process of displaying the information acquired in the determination process.

2. The wireless communication system according to claim 1, wherein
the mission management unit is further configured to perform
a process of checking whether a mission is selected as the terminal identification number, and
a process of selecting a mission corresponding to the character when the mission is not selected.

3. The wireless communication system according to claim 1, wherein
the mission includes a plurality of missions,
the mission registration unit is further configured to perform a process of classifying the registered missions by the character, and
assigning a different mission determination value for each mission,
the site survey tool is further configured to perform
a process of measuring a radio wave, and a process of transmitting the measured radio wave information to the server, and
the mission management unit is further configured to perform
a process of calculating the mission determination value based on the radio wave information, and
a process of selecting a mission assigned to the mission determination value.

4. The wireless communication system according to claim 1, wherein
the character is classified as Achiever, Explorer, Socializer, and a Killer by the Bartle Test.

5. The wireless communication system according to claim 4, wherein
the mission registered in the mission registration unit is
a mission to achieve a goal related to the number of measurements or measurement values, when the character is Achiever; and
a mission to explore challenges related to the number of measurements or measurement values, when the character is Explorer.

6. A wireless communication method implemented by a wireless communication system having a server and a site survey tool, wherein
the server includes a mission registration unit that includes one or more processors and a mission management unit that includes one or more processors, and
the method comprises:
by the mission registration unit, registering a mission set corresponding to character of an engineer;
by the site survey tool, transmitting character input by an engineer and a terminal identification number of the site survey tool to the server;
by the mission management unit,
making a determination corresponding to a mission selected as the terminal identification number, and
transmitting information acquired in the determination to a site survey tool corresponding to the terminal identification number; and
by the site survey tool, displaying the information acquired in the determination.

7. A wireless communication device for performing wireless communication with a site survey tool, the device comprising one or more processors and configured to perform
a process of registering a mission set corresponding to character of an engineer,
a process of receiving character input by an engineer and a terminal identification number of the site survey tool from the site survey tool,
a determination process of making a determination corresponding to a mission selected as the terminal identification number, and
a process of transmitting the information acquired in the determination process to the site survey tool corresponding to the terminal identification number.

8. A non-transitory computer storage medium storing a wireless communication program for causing the wireless communication device to perform the processes according to claim 7.

9. The wireless communication method according to claim 6, further comprising:
by the mission registration unit, a process of checking whether a mission is selected as the terminal identification number, and
by the mission registration unit, a process of selecting a mission corresponding to the character when the mission is not selected.

10. The wireless communication method according to claim 6, wherein
the mission includes a plurality of missions,
and the method further comprises:
classifying, by the mission registration unit, the registered missions by the character,
assigning, by the mission registration unit, a different mission determination value for each mission,
measuring, by the site survey tool, a radio wave,
transmitting, by the site survey tool, the measured radio wave information to the server,
calculating, by the mission registration unit, the mission determination value based on the radio wave information, and
selecting, by the mission registration unit, a mission assigned to the mission determination value.

11. The wireless communication method according to claim 6, wherein
the character is classified as Achiever, Explorer, Socializer, and a Killer by the Bartle Test.

12. The wireless communication method according to claim 11, wherein
the mission registered in the mission registration unit is
a mission to achieve a goal related to the number of measurements or measurement values, when the character is Achiever; and
a mission to explore challenges related to the number of measurements or measurement values, when the character is Explorer.
